(19) United States
(12) Patent Application Publication
(10) Pub. No.: US 2018/0356893 A1
(43) Pub. Date: Dec. 13, 2018

(54) SYSTEMS AND METHODS FOR VIRTUAL TRAINING WITH HAPTIC FEEDBACK

(71) Applicant: Tsunami VR, Inc., Del Mar, CA (US)

(72) Inventor: Naresh SONI, San Diego, CA (US)

(21) Appl. No.: 16/004,397

(22) Filed: Jun. 10, 2018

Related U.S. Application Data
(60) Provisional application No. 62/518,841, filed on Jun. 13, 2017.

(51) Int. Cl. G06F 3/01; G09B 19/00

(52) U.S. Cl. CPC G06F 3/016; G06F 3/017; G09B 19/003; G06F 3/014

(57) ABSTRACT

Determining physical profiles of physical objects using haptic gloves for use during virtual training of end users. Particular methods and systems detect when a first haptic glove is in contact with a physical object, determine physical profile data for the physical object based on outputs from sensors of the first haptic glove when in contact with the physical object, store the physical profile data in association with a virtual object that represents the physical object, and use the physical profile data to limit physical movement of a second haptic glove operated by an end user during a virtual training session.

### TECHNICAL FIELD

This disclosure relates to virtual reality (VR), augmented reality (AR), and mixed reality (MR) technologies.

### BACKGROUND

Virtual reality training does not adequately provide feedback to the user as to what the user is holding or touching during a virtual experience. Some hand-held controllers provide feedback in the form of vibrations, but such controllers are not capable of providing a realistic experience in relation to the feel of physical features represented by a virtual object presented to the user during the virtual experience. Thus, there is a need for better haptic feedback during virtual training.

### BRIEF DESCRIPTION OF THE DRAWINGS

FIG. 1A and FIG. 1B depict aspects of a system on which different embodiments are implemented for determining physical profiles of physical objects using haptic gloves for use during virtual training of end users.

FIG. 2 depicts a method for determining physical profiles of physical objects using haptic gloves for use during virtual training of end users.

FIG. 3 illustrates aspects of a method for determining physical profiles of physical objects using haptic gloves for use during virtual training of end users.

FIG. 4 is a block diagram of a method for haptic feedback virtual training in VR, AR, or MR.

### DETAILED DESCRIPTION

This disclosure relates to different approaches for determining physical profiles of physical objects using haptic gloves for use during virtual training of end users.

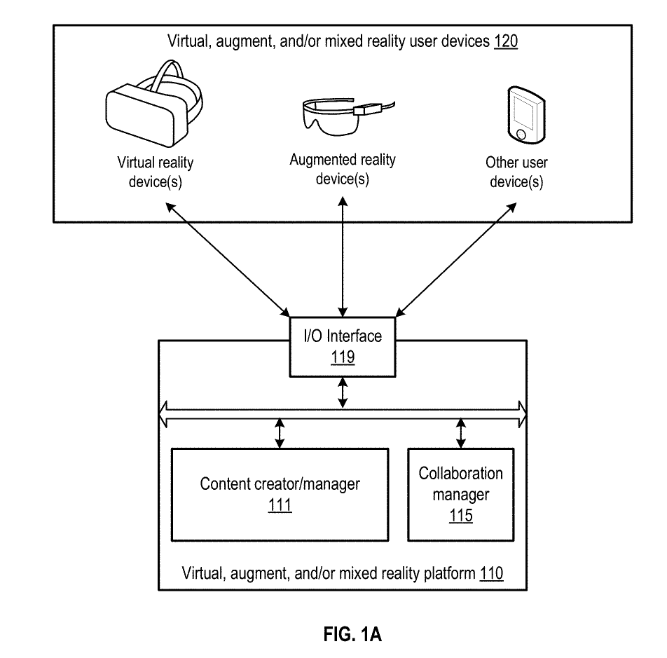

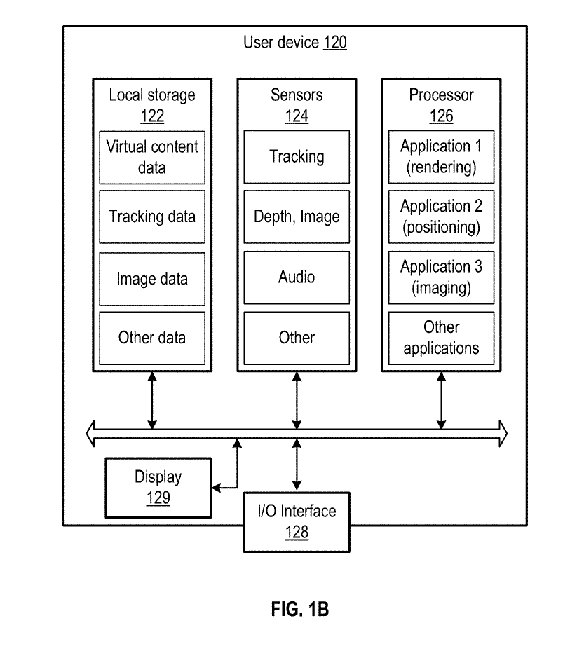

FIG. 1A and FIG. 1B depict aspects of a system on which different embodiments are implemented for determining physical profiles of physical objects using haptic gloves for use during virtual training of end users. The system includes a virtual, augmented, and/or mixed reality platform 110 (e.g., including one or more servers) that is communicatively coupled to any number of virtual, augmented, and/or mixed reality user devices 120 such that data can be transferred between the platform 110 and each of the user devices 120 as required for implementing the functionality described in this disclosure. General functional details about the platform 110 and the user devices 120 are discussed below before particular functions for determining physical profiles of physical objects using haptic gloves for use during virtual training of end users are discussed.

As shown in FIG. 1A, the platform 110 includes different architectural features, including a content creator/manager 111, a collaboration manager 115, and an input/output (I/O) interface 119. The content creator/manager 111 creates and stores visual representations of things as virtual content that can be displayed by a user device 120 to appear within a virtual or physical environment. Examples of virtual content include: virtual objects, virtual environments, avatars, video, images, text, audio, or other presentable data. The collaboration manager 115 provides virtual content to different user devices 120, and tracks poses (e.g., positions and orientations) of virtual content and of user devices as is known in the art (e.g., in mappings of environments, or other approaches). The I/O interface 119 sends or receives data between the platform 110 and each of the user devices 120.

Each of the user devices 120 include different architectural features, and may include the features shown in FIG. 1B, including a local storage component 122, sensors 124, processor(s) 126, an input/output (I/O) interface 128, and a display 129. The local storage component 122 stores content received from the platform 110 through the I/O interface 128, as well as information collected by the sensors 124. The sensors 124 may include: inertial sensors that track movement and orientation (e.g., gyros, accelerometers and others known in the art); optical sensors used to track movement and orientation of user gestures; position-location or proximity sensors that track position in a physical environment (e.g., GNSS, WiFi, Bluetooth or NFC chips, or others known in the art); depth sensors; cameras or other image sensors that capture images of the physical environment or user gestures; audio sensors that capture sound (e.g., microphones); and/or other known sensor(s). It is noted that the sensors described herein are for illustration purposes only and the sensors 124 are thus not limited to the ones described. The processor 126 runs different applications needed to display any virtual content within a virtual or physical environment that is in view of a user operating the user device 120, including applications for: rendering virtual content; tracking the pose (e.g., position and orientation) and the field of view of the user device 120 (e.g., in a mapping of the environment if applicable to the user device 120) so as to determine what virtual content is to be rendered on a display (not shown) of the user device 120; capturing images of the environment using image sensors of the user device 120 (if applicable to the user device 120); and other functions. The I/O interface 128 manages transmissions of data between the user device 120 and the platform 110. The display 129 may include, for example, a touchscreen display configured to receive user input via a contact on the touchscreen display, a semi or fully transparent display, or a non-transparent display. In one example, the display 129 includes a screen or monitor configured to display images generated by the processor 126. In another example, the display 129 may be transparent or semi-opaque so that the user can see through the display 129.

Particular applications of the processor 126 may include: a communication application, a display application, and a gesture application. The communication application may be configured to communicate data from the user device 120 to the platform 110 or to receive data from the platform 110, may include modules that may be configured to send images and/or videos captured by a camera of the user device 120 from sensors 124, and may include modules that determine the geographic location and the orientation of the user device 120 (e.g., determined using GNSS, WiFi, Bluetooth, audio tone, light reading, an internal compass, an accelerometer, or other approaches). The display application may generate virtual content in the display 129, which may include a local rendering engine that generates a visualization of the virtual content. The gesture application identifies gestures made by the user (e.g., predefined motions of the user's arms or fingers, or predefined motions of the user device 120 (e.g., tilt, movements in particular directions, or others). Such gestures may be used to define interaction or manipulation of virtual content (e.g., moving, rotating, or changing the orientation of virtual content).

Examples of the user devices 120 include VR, AR, MR and general computing devices with displays, including: head-mounted displays; sensor-packed wearable devices with a display (e.g., glasses); mobile phones; tablets; or other computing devices that are suitable for carrying out the functionality described in this disclosure. Depending on implementation, the components shown in the user devices 120 can be distributed across different devices (e.g., a worn or held peripheral separate from a processor running a client application that is communicatively coupled to the peripheral).

Having discussed features of systems on which different embodiments may be implemented, attention is now drawn to different processes for determining physical profiles of physical objects using haptic gloves for use during virtual training of end users.

### Determining Physical Profiles of Physical Objects Using Haptic Gloves for Use During Virtual Training of End Users

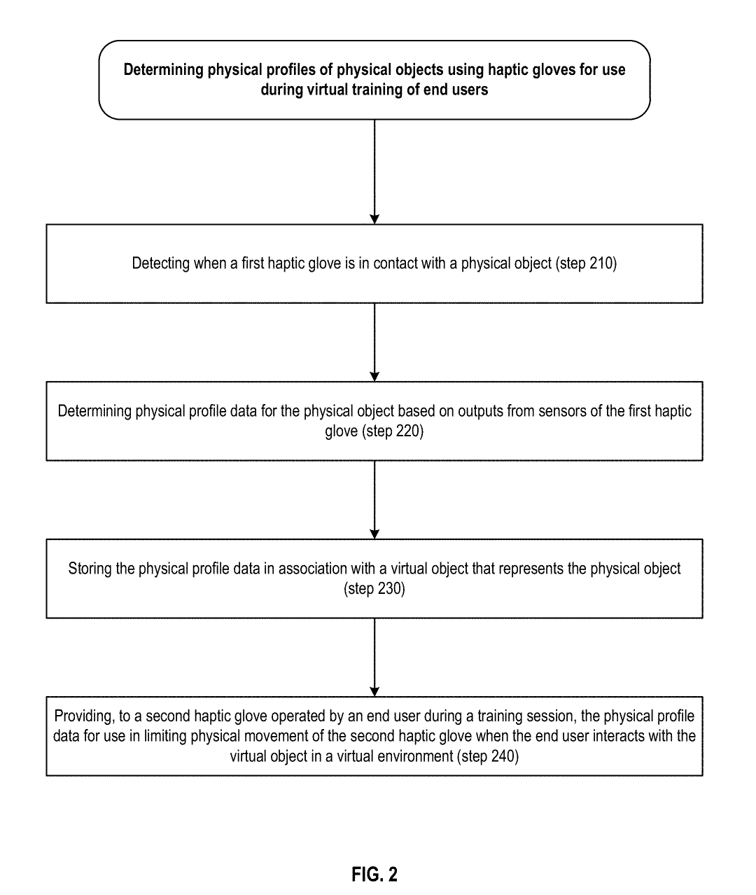

FIG. 2 depicts a method for determining physical profiles of physical objects using haptic gloves for use during virtual training of end users.

As shown, the method in FIG. 2 comprises: detecting when a first haptic glove is in contact with a physical object (step 210); after detecting when the first haptic glove is in contact with the physical object, determining physical profile data for the physical object based on outputs from sensors of the first haptic glove (step 220); storing the physical profile data in association with a virtual object that represents the physical object (step 230); and providing, to a second haptic glove operated by an end user during a virtual training session, the physical profile data for use in limiting physical movement of the second haptic glove when the end user uses the second haptic glove to interact with the virtual object in a virtual environment (step 240).

By way of example, detecting when the first haptic glove is in contact with the physical object can be achieved in different ways, such as a visual sensor (e.g., a camera) sensing the contact, pressure sensors of the glove sensing the contact and/or user input indicating the contact has occurred.

By way of example, determining physical profile data for the physical object based on outputs from sensors of the first haptic glove may include: measuring positions and orientations of sensors (e.g., flex or resistive sensors) and/or different components of the glove relative to each other.

In one embodiment of the method shown in FIG. 2, the method comprises: commencing, for the end user, a virtual training session during which the end user is expected to interact with the virtual object using the second haptic glove; receiving the physical profile data at a client device for use in controlling the second haptic glove during the training session; determining when the end user interacts with the virtual object in the virtual environment using the second haptic glove; and after determining that the end user is interacting with the virtual object using the second haptic glove, using the physical profile data to limit physical movement of the second haptic glove.

In one embodiment of the method shown in FIG. 2, commencing the virtual training session for the end user comprises: receiving a selection from the end user of the virtual training session; and determining that the physical profile data of the physical object is associated with a virtual object used in the virtual training session.

In one embodiment of the method shown in FIG. 2, the steps of the method may take different forms. Detecting when the first haptic glove is in contact with the physical object comprises moving the first haptic glove over a surface of the physical object and recording orientations of the first glove during the movement. Determining physical profile data for the physical object based on outputs from sensors of the first haptic glove comprises determining the physical profile data based on the recorded orientations of the first glove. Storing the physical profile data in association with the virtual object comprises transferring the physical profile data to a database and storing data that associates the physical profile data with the virtual object. Examples of data that associates the physical profile data with the virtual object includes an identifier of the virtual object stored in connection with the physical profile data, an identifier of the physical profile data stored in connection with the virtual object, or other known ways to associate two stored sets of data such that one set of data is identified as being associated with the other set of data.

In one embodiment of the method shown in FIG. 2, the physical profile data represents orientations and positions of sensors in the first haptic glove when the first haptic glove is in contact with the physical object.

In one embodiment of the method shown in FIG. 2, the physical profile data represents orientations and positions of components of the the first haptic glove relative to each other when the first haptic glove is in contact with the physical object.

In one embodiment of the method shown in FIG. 2, the physical profile data represents vibrations sensed by sensors of the first haptic glove when the first haptic glove is in contact with the physical object.

In one embodiment of the method shown in FIG. 2, the physical profile data represents shape, weight, size or motion of the physical object as sensed by sensors of the first haptic glove when the first haptic glove is in contact with the physical object.

In one embodiment of the method shown in FIG. 2, the method comprises: using the physical profile data to limit physical movement of the second haptic glove by instructing the second haptic glove to provide haptic feedback that prevents a hand of the end user that resides inside the second haptic glove from moving in a direction that would result in virtual movement of the end user's hand in the second haptic glove that passes through a surface of the virtual object.

In one embodiment of the method shown in FIG. 2, the physical object is a tool.

In one embodiment of the method shown in FIG. 2, the physical object is equipment.

In one embodiment of the method shown in FIG. 2, a client device uses the the physical profile data to control the second haptic glove, wherein the client device is a computing device. Examples of client devices include desktop computers, tablets, smartphones, a head-mounted device, servers, or another suitable machine for sending instructions to the glove that control the glove.

In one embodiment of the method shown in FIG. 2, the method comprises: displaying the virtual environment to the end user on a virtual reality device, an augmented reality device, or a mixed reality device.

In one embodiment of the method shown in FIG. 2, the first haptic glove and the second haptic glove are the same glove.

In one embodiment of the method shown in FIG. 2, the first haptic glove and the second haptic glove are different gloves.

Any of the above embodiments of the method shown in FIG. 2 can track an interaction by the end user with the virtual object and provide instructions to the glove worn by the end user based on the interaction—e.g., if the end user is manipulating the glove such that a virtual position of the glove intersects with or is next to a position of a surface of the virtual object, then instructions are provided to the glove to actuate haptic feedback components that prevent the fingers or hand of the end user from moving through a programmed outer boundary of the virtual object so as to simulate a sensation of touching the virtual object. The physical profile data may include sensed positions and orientations of sensors of the first glove when the first glove is in contact with a particular surface of the physical object. Those positions and orientations can be associated with the particular surface of the physical object (e.g., via visual tracking) and later used to provide instructions to haptic feedback components of the glove worn by the end user when the end user's hand is tracked as being in contact with a surface of the virtual object that corresponds to that particular surface of the physical object. Data read from the sensors of the first haptic glove can be used to define positions and orientations or other states (e.g., vibrations, exerted pressure) of haptic feedback components of the second haptic glove. Actuators can be used to control the haptic feedback components (e.g., based on the recorded positions and orientations). Examples of haptic feedback components include vibration motors, tension components (e.g., flex or resistive sensors capable of variable resistance settings depending on instructions), or other suitable components.

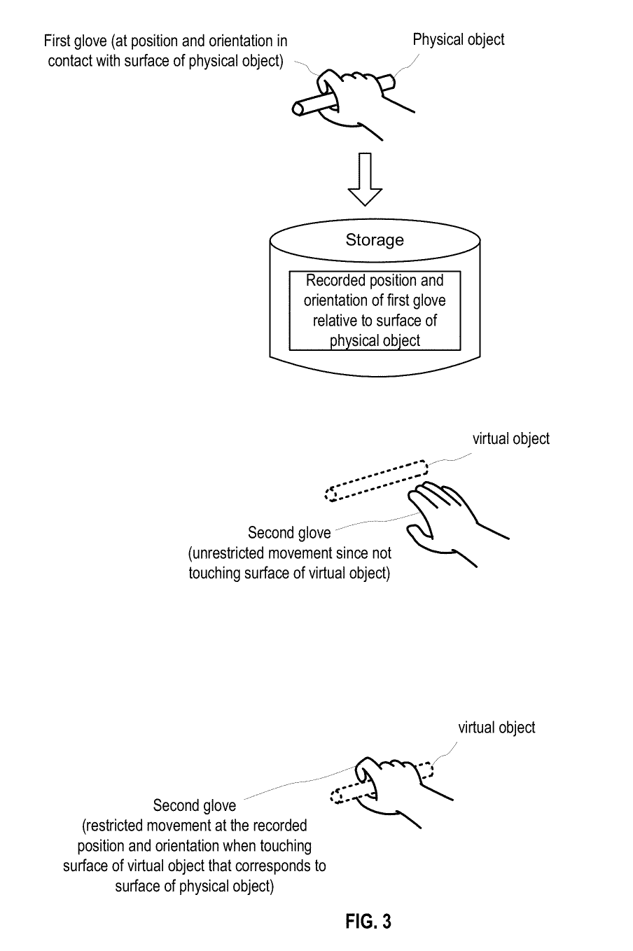

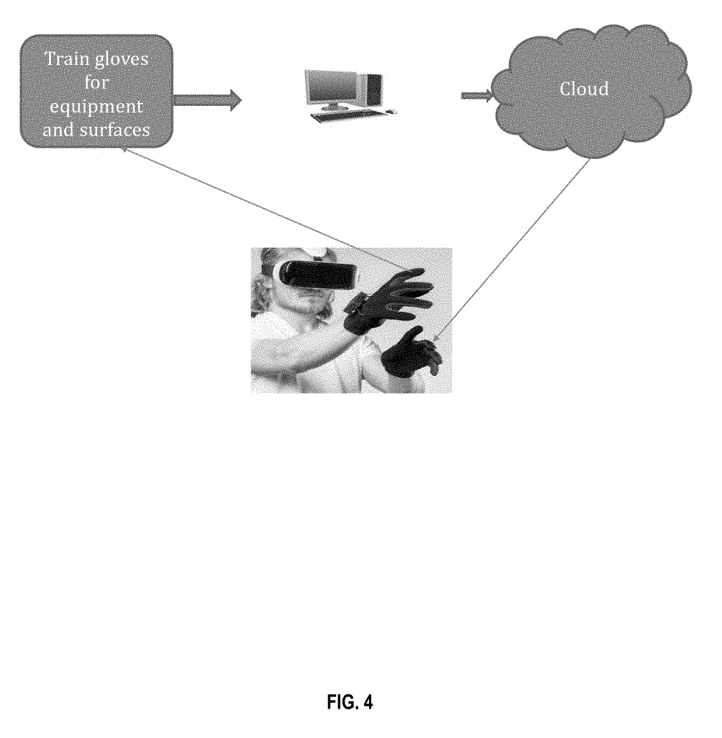

FIG. 3 illustrates aspects of a method for determining physical profiles of physical objects using haptic gloves for use during virtual training of end users. As shown, a position and orientation of a first glove is determined when the first glove is in contact with a surface of a physical object. The recorded position and orientation of the first glove relative to the surface of the physical object is stored. A second glove operated by an end user during a virtual training session has unrestricted movement while the virtual position of the second glove is not touching a surface of the virtual object. When the virtual position of the second glove moves to the recorded position and orientation while touching a surface of the virtual object that corresponds to the surface of the physical object, physical movement of the second glove is restricted such that the end user cannot manipulate the virtual position of the glove through the surface of the virtual object. The virtual position of the glove in the virtual environment can be tracked using known approaches. In VR, a virtual representation of positions and orientations of different components of the glove relative to the end user is shown on a VR user device to the end user, where the virtual representation mimics the actual positions and orientations of those components relative to the end user. In AR, the positions and orientations of different components of the glove relative to the end user can be tracked relative to the virtual object shown on a VR user device to the end user.

### OTHER EMBODIMENTS

Aspects of this disclosure provide relevant feedback to the user based on what they are doing and experiencing during training and simulation, and provide real-time and correct feedback to the users to accelerate training and simulation of complex equipment or process.

One embodiment is a method for haptic feedback for VR training. The method includes wearing at least one training VR glove connected to a training VR system, the at least one training VR glove comprising a glove body and a plurality of haptic sensors. The method also includes programming the plurality of haptic sensors by touching an article with the at least one training VR glove and moving the at least one training VR glove over a surface of the article to generate training data. The method also includes transferring the training data from the training VR system to a database.

Another embodiment is a method for haptic feedback for MR training. The method includes wearing at least one training MR glove connected to a training MR system, the at least one training MR glove comprising a glove body and a plurality of haptic sensors. The method also includes programming the plurality of haptic sensors by touching an article with the at least one training MR glove and moving the at least one training MR glove over a surface of the article to generate training data. The method also includes transferring the training data from the training MR system to a database.

Yet another embodiment is a method for haptic feedback for AR training. The method includes wearing at least one training AR glove connected to a training AR system, the at least one training AR glove comprising a glove body and a plurality of haptic sensors. The method also includes programming the plurality of haptic sensors by touching an article with the at least one training AR glove and moving the at least one training AR glove over a surface of the article to generate training data. The method also includes transferring the training data from the training AR system to a database.

Another embodiment is a system for haptic feedback for VR training. The system comprises at least one training VR glove comprising a glove body and a plurality of haptic sensors, a training VR system, an article, and a database. The training VR system is configured to program the plurality of haptic sensors by touching the article with the at least one training VR glove and moving the at least one training VR glove over a surface of the article to generate training data. The training VR system is configured to transfer the training data from the training VR system to the database.

Another embodiment is a system for haptic feedback for MR training. The system comprises at least one training MR glove comprising a glove body and a plurality of haptic sensors, a training MR system, an article, and a database. The training MR system is configured to program the plurality of haptic sensors by touching the article with the at least one training MR glove and moving the at least one training MR glove over a surface of the article to generate training data. The training MR system is configured to transfer the training data from the training MR system to the database.

Another embodiment is a system for haptic feedback for AR training. The system comprises at least one training AR glove comprising a glove body and a plurality of haptic sensors, a training AR system, an article, and a database. The training AR system is configured to program the plurality of haptic sensors by touching the article with the at least one training AR glove and moving the at least one training AR glove over a surface of the article to generate training data. The training AR system is configured to transfer the training data from the training AR system to the database.

Aspects of this disclosure provide a true glove experience to users over an entire hand, and the profile of the equipment is configured using a cloud connection. This procedure reduces the time it takes to train a user of VR/AR gloves, and efficacy of the process is much higher.

A user sets up the glove feedback using the surface or tool a user needs to operate. A profile is uploaded to a cloud computing service. When a user starts a training or simulation, the profile is downloaded from the cloud computing service. The profile for the training contains feedback for the glove.

When the user uses the equipment, or touches a surface, the haptic feedback is activated at an appropriate time.

A glove with sensors and haptics is used for training, which prepares a user for simulation and training exercise.

The gloves are trained with appropriate equipment and surfaces. This provides for an appropriate simulation and training with haptic feedback.

The training data is sent to the cloud computing service, and tagged with appropriate training and simulation. A simulation and training database is created for haptic feedback.

A user starts training by wearing the AR/VR gloves. Based on the training selected by the user, an appropriate haptic feedback is generated from the gloves based on the equipment that is being handled by the user or the surface being touched.

The AR/VR gloves are embedded with multiple sensors. The sensors on the glove are programmed by touching and moving the user's hands on the surface of the equipment and this programming information is transmitted to a cloud computing service.

One example of training is repairing equipment with tools, such as screw drivers, powered tools, etc. The programming ensures that the user gets an appropriate feedback from the AR/VR gloves. During training, the feedback from the repair equipment or the surface it touches provides feedback via that glove using the information that is downloaded from cloud for that specific experience.

In a method, a user wears the glove and prepares for learning of equipment and surfaces that will be used. The glove is trained for equipment and surface that is being used for training and simulation and the information is sent to the cloud associated with that training and simulation. The user is now ready for simulation and training with appropriate haptic feedback. The user selects a simulation or training program. Appropriate haptic information for the glove is downloaded to a PC/mobile/tablets or head mounted displays. The user goes through the training or simulation exercise and appropriate haptic feedback is generated to the glove. User gets real-time and true haptic feedback.

Glove sensors provide haptic feedback from the sensory motors.

Upload the training information related to simulation or training to the cloud. Cloud provides appropriate configuration when a user requests training or simulation.

One embodiment provides haptic feedback to the entire hand.

One embodiment provides haptic feedback that is based on operating equipment or touching a surface on the entire forehand.

One embodiment of a method for haptic feedback for VR training includes wearing at least one training VR glove connected to a training VR system, the at least one training VR glove comprising a glove body and a plurality of haptic sensors. The method also includes programming the plurality of haptic sensors by touching an article with the at least one training VR glove and moving the at least one training VR glove over a surface of the article to generate training data. The method also includes transferring the training data from the training VR system to a database.

An embodiment of a method for haptic feedback for MR training includes wearing at least one training MR glove connected to a training MR system, the at least one training MR glove comprising a glove body and a plurality of haptic sensors. The method also includes programming the plurality of haptic sensors by touching an article with the at least one training MR glove and moving the at least one training MR glove over a surface of the article to generate training data. The method also includes transferring the training data from the training MR system to a database.

An embodiment of a method for haptic feedback for AR training includes wearing at least one training AR glove connected to a training AR system, the at least one training AR glove comprising a glove body and a plurality of haptic sensors. The method also includes programming the plurality of haptic sensors by touching an article with the at least one training AR glove and moving the at least one training AR glove over a surface of the article to generate training data. The method also includes transferring the training data from the training AR system to a database.

The method further includes commencing a VR training session for utilization of the article, downloading the training data to a VR system comprising a VR head mounted display (HMD) and a VR glove, and training using the training data wherein haptic feedback is provided to the user.

An embodiment of a system for haptic feedback for VR training comprises at least one training VR glove comprising a glove body and a plurality of haptic sensors, a training VR system, an article, and a database. The training VR system is configured to program the plurality of haptic sensors by touching the article with the at least one training VR glove and moving the at least one training VR glove over a surface of the article to generate training data. The training VR system is configured to transfer the training data from the training VR system to the database.

An embodiment of a system for haptic feedback for MR training comprises at least one training MR glove comprising a glove body and a plurality of haptic sensors, a training MR system, an article, and a database. The training MR system is configured to program the plurality of haptic sensors by touching the article with the at least one training MR glove and moving the at least one training MR glove over a surface of the article to generate training data. The training MR system is configured to transfer the training data from the training MR system to the database.

An embodiment of a system for haptic feedback for AR training comprises at least one training AR glove comprising a glove body and a plurality of haptic sensors, a training AR system, an article, and a database. The training AR system is configured to program the plurality of haptic sensors by touching the article with the at least one training AR glove and moving the at least one training AR glove over a surface of the article to generate training data. The training AR system is configured to transfer the training data from the training AR system to the database.

The article is preferably equipment. Alternatively, the article is a tool. Alternatively, the article is any physical thing (e.g., an apparatus, appliance, device, contraption, mechanism, gadget, or other thing to be interacted with by a user).

A second training VR glove is optional.

The VR system further comprises a client device in communication with a display device and the VR glove, and a collaboration manager, the client device in communication with the collaboration manager, and the display device in communication with the client device. The display device is preferably a head mounted display (HMD), but may be selected from the group comprising a desktop computer, a laptop computer, a tablet computer, a mobile phone, an AR headset, and a virtual reality (VR) headset.

The client device is preferably a personal computer, laptop computer, tablet computer or mobile computing device such as a smartphone.

User interface elements may include the capacity viewer and mode changer.

The human eye's performance. 150 pixels per degree (foveal vision). Field of view Horizontal: 145 degrees per eye Vertical 135 degrees. Processing rate: 150 frames per second Stereoscopic vision Color depth: 10 million? (Let's decide on 32 bits per pixel)=470 megapixels per eye, assuming full resolution across entire FOV (33 megapixels for practical focus areas) Human vision, full sphere: 50 Gbits/sec. Typical HD video: 4 Mbits/sec and we would need >10,000 times the bandwidth. HDMI can go to 10 Mbps.

For each selected environment there are configuration parameters associated with the environment that the author must select, for example, number of virtual or physical screens, size/resolution of each screen, and layout of the screens (e.g. carousel, matrix, horizontally spaced, etc). If the author is not aware of the setup of the physical space, the author can defer this configuration until the actual meeting occurs and use the Narrator Controls to set up the meeting and content in real-time.

The following is related to a VR meeting. Once the environment has been identified, the author selects the AR/VR assets that are to be displayed. For each AR/VR asset the author defines the order in which the assets are displayed. The assets can be displayed simultaneously or serially in a timed sequence. The author uses the AR/VR assets and the display timeline to tell a “story” about the product. In addition to the timing in which AR/VR assets are displayed, the author can also utilize techniques to draw the audience's attention to a portion of the presentation. For example, the author may decide to make an AR/VR asset in the story enlarge and/or be spotlighted when the “story” is describing the asset and then move to the background and/or darken when the topic has moved on to another asset.

When the author has finished building the story, the author can play a preview of the story. The preview playout of the story as the author has defined but the resolution and quality of the AR/VR assets are reduced to eliminate the need for the author to view the preview using AR/VR headsets. It is assumed that the author is accessing the story builder via a web interface, so therefore the preview quality should be targeted at the standards for common web browsers.

After the meeting organizer has provided all the necessary information for the meeting, the Collaboration Manager sends out an email to each invitee. The email is an invite to participate in the meeting and also includes information on how to download any drivers needed for the meeting (if applicable). The email may also include a preload of the meeting material so that the participant is prepared to join the meeting as soon as the meeting starts.

The Collaboration Manager also sends out reminders prior to the meeting when configured to do so. Both the meeting organizer or the meeting invitee can request meeting reminders. A meeting reminder is an email that includes the meeting details as well as links to any drivers needed for participation in the meeting.

Prior to the meeting start, the user needs to select the display device the user will use to participate in the meeting. The user can use the links in the meeting invitation to download any necessary drivers and preloaded data to the display device. The preloaded data is used to ensure there is little to no delay experienced at meeting start. The preloaded data may be the initial meeting environment without any of the organization's AR/VR assets included. The user can view the preloaded data in the display device, but may not alter or copy it.

At meeting start time each meeting participant can use a link provided in the meeting invite or reminder to join the meeting. Within 1 minute after the user clicks the link to join the meeting, the user should start seeing the meeting content (including the virtual environment) in the display device of the user's choice. This assumes the user has previously downloaded any required drivers and preloaded data referenced in the meeting invitation.

Each time a meeting participant joins the meeting, the story Narrator (i.e. person giving the presentation) gets a notification that a meeting participant has joined. The notification includes information about the display device the meeting participant is using. The story Narrator can use the Story Narrator Control tool to view each meeting participant's display device and control the content on the device. The Story Narrator Control tool allows the Story Narrator to.

View all active (registered) meeting participants

View all meeting participant's display devices

View the content the meeting participant is viewing

View metrics (e.g. dwell time) on the participant's viewing of the content

Change the content on the participant's device

Enable and disable the participant's ability to fast forward or rewind the content

Each meeting participant experiences the story previously prepared for the meeting. The story may include audio from the presenter of the sales material (aka meeting coordinator) and pauses for Q&A sessions. Each meeting participant is provided with a menu of controls for the meeting. The menu includes options for actions based on the privileges established by the Meeting Coordinator defined when the meeting was planned or the Story Narrator at any time during the meeting. If the meeting participant is allowed to ask questions, the menu includes an option to request permission to speak. If the meeting participant is allowed to pause/resume the story, the menu includes an option to request to pause the story and once paused, the resume option appears. If the meeting participant is allowed to inject content into the meeting, the menu includes an option to request to inject content.

The meeting participant can also be allowed to fast forward and rewind content on the participant's own display device. This privilege is granted (and can be revoked) by the Story Narrator during the meeting.

After an AR story has been created, a member of the maintenance organization that is responsible for the “tools” used by the service technicians can use the Collaboration Manager Front-End to prepare the AR glasses to play the story. The member responsible for preparing the tools is referred to as the tools coordinator.

In the AR experience scenario, the tools coordinator does not need to establish a meeting and identify attendees using the Collaboration Manager Front-End, but does need to use the other features provided by the Collaboration Manager Front-End. The tools coordinator needs a link to any drivers necessary to playout the story and needs to download the story to each of the AR devices. The tools coordinator also needs to establish a relationship between the Collaboration Manager and the AR devices. The relationship is used to communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

Ideally Tsunami would build a function in the VR headset device driver to “scan” the live data feeds for any alarms and other indications of a fault. When an alarm or fault is found, the driver software would change the data feed presentation in order to alert the support team member that is monitoring the virtual NOC.

The support team member also needs to establish a relationship between the Collaboration Manager and the VR headsets. The relationship is used to connect the live data feeds that are to be displayed on the Virtual NOCC to the VR headsets. communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

The story and its associated access rights are stored under the author's account in Content Management System. The Content Management System is tasked with protecting the story from unauthorized access. In the virtual NOCC scenario, the support team member does not need to establish a meeting and identify attendees using the Collaboration Manager Front-End, but does need to use the other features provided by the Collaboration Manager Front-End. The support team member needs a link to any drivers necessary to playout the story and needs to download the story to each of the VR head.

The Asset Generator is a set of tools that allows a Tsunami artist to take raw data as input and create a visual representation of the data that can be displayed in a VR or AR environment. The raw data can be virtually any type of input from: 3D drawings to CAD files, 2D images to power point files, user analytics to real time stock quotes. The Artist decides if all or portions of the data should be used and how the data should be represented. The i Artist is empowered by the tool set offered in the Asset Generator.

The Content Manager is responsible for the storage and protection of the Assets. The Assets are VR and AR objects created by the Artists using the Asset Generator as well as stories created by users of the Story Builder.

Asset Generation Sub-System: Inputs: from anywhere it can: Word, Powerpoint, Videos, 3D objects etc. and turns them into interactive objects that can be displayed in AR/VR (HMD or flat screens). Outputs: based on scale, resolution, device attributes and connectivity requirements.

Story Builder Subsystem: Inputs: Environment for creating the story. Target environment can be physical and virtual. Assets to be used in story; Library content and external content (Word, Powerpoint, Videos, 3D objects etc). Output: Story; =Assets inside an environment displayed over a timeline. User Experience element for creation and editing.

CMS Database: Inputs: Manages The Library, Any asset: AR/VR Assets, MS Office files and other 2D files and Videos. Outputs: Assets filtered by license information.

Collaboration Manager Subsystem. Inputs: Stories from the Story Builder, Time/Place (Physical or virtual)/Participant information (contact information, authentication information, local vs. Geographically distributed). During the gathering/meeting gather and redistribute: Participant real time behavior, vector data, and shared real time media, analytics and session recording, and external content (Word, Powerpoint, Videos, 3D objects etc). Output: Story content, allowed participant contributions Included shared files, vector data and real time media; and gathering rules to the participants. Gathering invitation and reminders. Participant story distribution. Analytics and session recording (Where does it go). (Out-of-band access/security criteria).

Device Optimization Service Layer. Inputs: Story content and rules associated with the participant. Outputs: Analytics and session recording. Allowed participant contributions.

Rendering Engine Obfuscation Layer. Inputs: Story content to the participants. Participant real time behavior and movement. Outputs: Frames to the device display. Avatar manipulation

Real-time platform: The RTP This cross-platform engine is written in C++ with selectable DirectX and OpenGL renderers. Currently supported platforms are Windows (PC), iOS (iPhone/iPad), and Mac OS X. On current generation PC hardware, the engine is capable of rendering textured and lit scenes containing approximately 20 million polygons in real time at 30 FPS or higher. 3D wireframe geometry, materials, and lights can be exported from 3DS MAX and Lightwave 3D modeling/animation packages. Textures and 2D UI layouts are imported directly from Photoshop PSD files. Engine features include vertex and pixel shader effects, particle effects for explosions and smoke, cast shadows blended skeletal character animations with weighted skin deformation, collision detection, Lua scripting language of all entities, objects and properties.

### Other Aspects

Each method of this disclosure can be used with virtual reality (VR), augmented reality (AR), and/or mixed reality (MR) technologies. Virtual environments and virtual content may be presented using VR technologies, AR technologies, and/or MR technologies. By way of example, a virtual environment in AR may include one or more digital layers that are superimposed onto a physical (real world environment).

The user of a user device may be a human user, a machine user (e.g., a computer configured by a software program to interact with the user device), or any suitable combination thereof (e.g., a human assisted by a machine, or a machine supervised by a human)

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed. By way of example, machines may include one or more computing device(s), processor(s), controller(s), integrated circuit(s), chip(s), system(s) on a chip, server(s), programmable logic device(s), other circuitry, and/or other suitable means described herein or otherwise known in the art. One or more machines that are configured to perform the methods or operations comprising the steps of any methods described herein are contemplated. Systems that include one or more machines and the one or more non-transitory machine-readable media embodying program instructions that, when executed by the one or more machines, cause the one or more machines to perform or implement operations comprising the steps of any methods described herein are also contemplated. Systems comprising one or more modules that perform, are operable to perform, or adapted to perform different method steps/stages disclosed herein are also contemplated, where the modules are implemented using one or more machines listed herein or other suitable hardware.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Processes described above and shown in the figures include steps that are performed at particular machines. In alternative embodiments, those steps may be performed by other machines (e.g., steps performed by a server may be performed by a user device if possible, and steps performed by the user device may be performed by the server if possible).

When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

### RELATED APPLICATIONS

This application relates to the following related application(s): U.S. Pat. Appl. No. 62/518,841, filed 2017 Jun. 13, entitled METHOD AND SYSTEM FOR HAPTIC FEEDBACK FOR VIRTUAL REALITY TRAINING. The content of each of the related application(s) is hereby incorporated by reference herein in its entirety.

1. A method for determining physical profiles of physical objects using haptic gloves for use during virtual training of end users, the method comprising:
detecting when a first haptic glove is in contact with a physical object;
after detecting when the first haptic glove is in contact with the physical object, determining physical profile data for the physical object based on outputs from sensors of the first haptic glove;
storing the physical profile data in association with a virtual object that represents the physical object; and
providing, to a second haptic glove operated by an end user during a virtual training session, the physical profile data for use in limiting physical movement of the second haptic glove when the end user uses the second haptic glove to interact with the virtual object in a virtual environment.

2. The method of claim 1, wherein the method comprises:
commencing, for the end user, the virtual training session during which the end user is expected to interact with the virtual object using the second haptic glove;
receiving the physical profile data at a client device for use in controlling the second haptic glove during the training session;
determining when the end user interacts with the virtual object in the virtual environment using the second haptic glove; and
after determining that the end user is interacting with the virtual object using the second haptic glove, using the physical profile data to limit physical movement of the second haptic glove.

3. The method of claim 2, wherein commencing the virtual training session for the end user comprises:
receiving a selection from the end user of the virtual training session; and
determining that the physical profile data of the physical object is associated with a virtual object used in the virtual training session.

4. The method of claim 1,
wherein detecting when the first haptic glove is in contact with the physical object comprises moving the first haptic glove over a surface of the physical object and recording orientations of the first glove during the movement,
wherein determining physical profile data for the physical object based on outputs from sensors of the first haptic glove comprises determining the physical profile data based on the recorded orientations of the first glove, and
wherein storing the physical profile data in association with the virtual object comprises transferring the physical profile data to a database and storing data that associates the physical profile data with the virtual object.

5. The method of claim 1, wherein the physical profile data represents orientations and positions of sensors in the first haptic glove when the first haptic glove is in contact with the physical object.

6. The method of claim 1, wherein the physical profile data represents vibrations sensed by sensors of the first haptic glove when the first haptic glove is in contact with the physical object.

7. The method of claim 1, wherein the physical profile data represents shape, weight, size or motion of the physical object as sensed by sensors of the first haptic glove when the first haptic glove is in contact with the physical object.

8. The method of claim 1, wherein the method comprises:
using the physical profile data to limit physical movement of the second haptic glove by instructing the second haptic glove to provide haptic feedback that prevents a hand of the end user that resides inside the second haptic glove from moving in a direction that would result in virtual movement of the hand that passes through a surface of the virtual object.

9. The method of claim 1, wherein the physical object is a tool.

10. The method of claim 1, wherein the physical object is equipment.

11. The method of claim 1, wherein a client device uses the the physical profile data to control the second haptic glove, wherein the client device is a computing device.

12. The method of claim 1, wherein the method comprises: displaying the virtual environment to the end user on a virtual reality device, an augmented reality device, or a mixed reality device.

13. The method of claim 1, wherein the first haptic glove and the second haptic glove are the same glove.

14. The method of claim 1, wherein the first haptic glove and the second haptic glove are different gloves.

15. One or more non-transitory machine-readable media embodying program instructions that, when executed by one or more machines, cause the one or more machines to implement the method of claim 1.
